(19) United States
(12) Patent Application Publication
(10) Pub. No.: US 2005/0238021 A1
(43) Pub. Date: Oct. 27, 2005

(54) Integral router device

(76) Inventors: Shao-Hsian Hsu, Miaoli City (TW); Chih-Liang Shen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/829,336

(22) Filed: Apr. 22, 2004

(51) Int. Cl. H04L 12/28

(52) U.S. Cl. 370/392; 709/238

(57) ABSTRACT

The present invention is related to an integral router device, especially to the router with a bridge function comprises at least a ROM, a RAM, a processor, a LAN interface, a wireless card and an antenna device in order to have the most functions with the least number of devices and be power saving while operating.

### BACKGROUND OF THE INVENTION

The present invention is related to an integral router device, especially to the router with a bridge function comprises at least a ROM, a RAM, a processor, a LAN interface, a wireless card and an antenna.

With the period of information coming, there is a tendency toward a life of information modernly and the invention of network has a deep influence on the livelihood. With the popularization of networks and the gradual simplification in not only the price, but also the relative settings, the convenience accompanying with the information popularizing is not only belonged to a small number of people who are good at techniques anymore.

By the nearly unlimited connection of the network, restriction of the availability and convenience of books, magazines and televisions has been broken. Getting the relative data and message by a network connection to any connectable domain in the world, the strengthening of functions of hardware related to connections and the simplification of the settings improve the effect of networks on people. As a result, a variety of broadband networks appear in every family and cybercafes everywhere meet people's demands for more convenient and quickly Internet surfing. With the development and popularization of the hardware, Internet surfing by a single unit cannot satisfy the demands for quickly getting more data in the network; besides, the slashing of price of the hardware tends to make the user have a second, a third and even more network connecting devices in the future.

Therefore, a variety of relative hardware that configured to set up a small-scale domain is put on the market gradually; wherein, routers are applied more popularly. A router device is a network apparatus, which configured to provide a connection among multiple networks or domains. The router can translate the data and message from different networks or domains, to make the networks and domains understand the data from one another and therefore a larger network is composed. There are two typical functions of a router device: one is the data channel and the other is controlling. The function of data channel, which includes the decision of transmitting, the back-panel transmitting and the dispatching of output chain-circuit, is generally worked by specific hardware; the function of controlling, including the message exchanging with a next router, the systematic equipment and the systematic management, is generally worked by software. By the collocation of the router device and the server device in addition to the appropriate software, users can build up an internal network of a small scale, wherein the connection between the multi network hardware and an external network is by a means of original single point network connecting and needs no connecting points additionally. It is the most economic way for the users who want to expand the hardware for connecting and to simultaneously connect multiple computers.

On the other hand, accompanying with the rapid expansion of the connecting hardware, the amount (at least one) of connecting lines of the known hardware is correspondingly increased and this may result in a big restriction of succinctness of the operating interface and the convenience of mobile operating. Therefore, a variety of wireless transmitting interfaces are developed, wherein IR is often used to transmit a smaller file, or to transmit through a short distance in early days and IEEE 802.11b/g, totally named Hi-Fi, is used to transmit a larger file, or through a long distance, recently. By the wireless connecting, the practicability of the small scale LAN can be improved and people need not to be restricted to a specific place while using.

However, the increment of space of the used hardware and apparatus is possibly a big persecution to the user who has finite space. In addition, the total power consumed is much more while multiple hardware or apparatus operating simultaneously. There is still a great effort needed doing in reducing the required space of configuring the relative hardware or apparatus and in reducing the power consuming.

### SUMMARY OF THE INVENTION

The present invention relates to an integral router device. The main purpose is to provide a connection to a wireless LAN, wherein the router has the most functions with the least devices by a means of integrating internal hardware while operating.

The present invention relates to an integral router device. One another purpose is to provide a low power connection to a wireless LAN, wherein the router has the most functions with the least devices by a means of integrating hardware while operating.

The present invention relates to an integral router device, especially to the router with a bridge function. The router device at least comprises a ROM to store programs when operating hardware related to the programs, a RAM to provide an area for temporarily storing processing data, a processor to process the processing data, a LAN interface connecting to an external network to transmit and receive the relative data, a wireless card to switch format of transmitting data and to transmit and receive wireless data by an antenna. In addition, the router of the invention can be functional integrated with a server to reduce the space of hardware and total consuming of the operating power; furthermore, by integrated with the server, the practicability of the server can be enlarge.

In order to make people who are familiar to the technique understand the purpose, characteristics and effects of the present invention, other features and advantages of the invention will be apparent from the following description taken in conjunction with the accompanying drawings.

### BRIEF DESCRIPTION OF THE DRAWINGS

FIG. 1 is a block diagram of a preferred embodiment of the invention.

FIG. 2 is a block diagram of another embodiment of the invention.

### DETAILED DESCRIPTION OF THE PREFERRED EMBODIMENT

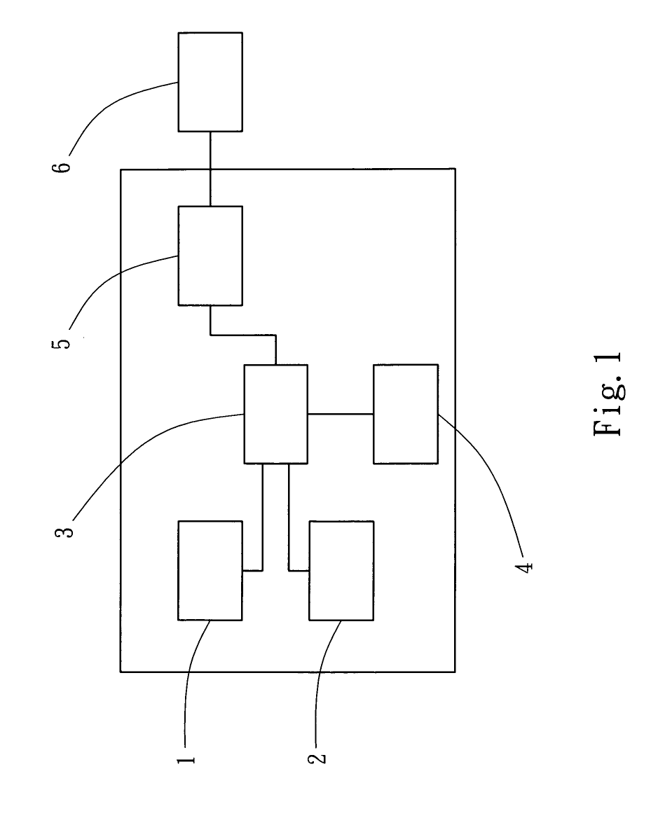

With reference to FIG. 1, which is the representative diagram of the present invention. The invention is related to an integral router, especially to the router device with a bridge function, wherein the component 1 is a ROM, which configured to store programs when a processor 3 operates and to connect with the processor 3 by means of electrically connection; the component 2 is a RAM, which configured to connect with the processor 3 by means of electrically connection and to store data processed by the processor 3; the component 3 is a processor, which configured to process data obtained from a LAN interface 4, or a wireless card 5 with a antenna 6 and to transmit the data to a correspondingly connected network through the LAN interface 4 or the wireless card 5 with the antenna 6 by means of electrically connection, or to transmit the processed data to the RAM 2 for temporary storing by means of electrically connection; the component 4 is a LAN interface, which configured to provide the router a connection to an external network and the LAN interface 4 is connected with the processor 3 by means of electrically connection; the component 5 is a wireless card device and the component 6 is an antenna that configured to provide the router a connection with the processor by means of electrically connection. Wherein, the processor 3 can be CPU (central processor unit); the ROM 1 can be flash ROM; the RAM 2 can be SDRAM; the wireless card 5 is electrically-connected with the processor 3 by mini PCI bus (mini peripheral component interconnect bus); the antenna 6 can be exposed outside the shell of the router.

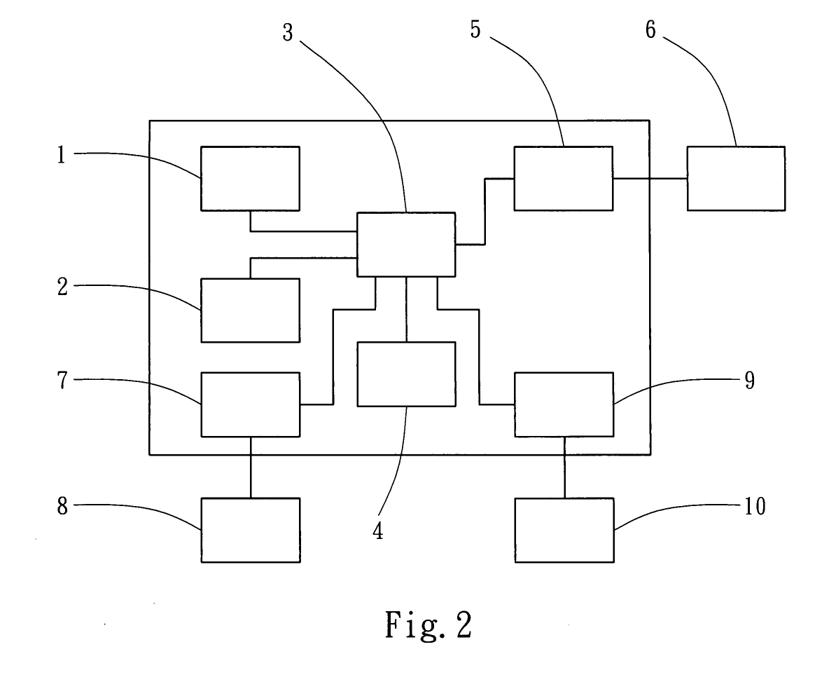

With reference to FIG. 2, which is another embodiment of the present invention. The invention is related to an integral router device, especially to the router with a bridge function, wherein the component 1 is a ROM, which configured to store programs when a processor 3 operates and to connect with the processor 3 by means of electrically connection; the component 2 is a RAM, which configured to connect with the processor 3 by means of electrically connection and to store data processed by the processor 3; the component 3 is a processor, which configured to process data obtained from a LAN interface 4, or a wireless card 5 with an antenna 6 and to transmit the data to a corresponding connected network through the LAN interface 4 or the wireless card 5 with the antenna 6 by means of electrically connection, or to transmit the processed data to the RAM 2 for temporary storing by means of electrically connection; the component 4 is a LAN interface, which configured to provide the router a connection to an external network and the LAN interface 4 is connected with the processor 3 by means of electrically connection; the component 5 is a wireless card device and the component 6 is an antenna that configured to provide the router a connection to an internal network and the wireless card 5 and the antenna 6 are connected with the processor 3 by means of electrically connection. Wherein, the processor 3 can be CPU; the ROM 1 can be EEROM (electrically erasable and programmable ROM); the RAM 2 can be DDR RAM (double duration rate random access memory); the wireless card 5 is electrically-connected with the processor 3 by mini PCI bus; the antenna 6 can be hid inside the shell of the router. In addition, the router can furthermore have an internal storage controller 7, which is connected with and controls an internal storage device 8 through an appropriate means of electrically connection, for the purpose of data storing and reading by the router; an internal storage 8 connected with the internal storage controller 7 by means of electrically connection, to store and read the data; an external storage controller 9 is appropriately electrically connected with and controls an external storage 10 for the data storing and reading by the router; an external storage 10 is appropriately electrically connected with and controls an external storage controller 9 for the data storing and reading by the router. Wherein, the internal storage controller 7 is connected with and controls the internal storage 8 by an IDE (integral device electronic); the external storage controller 9 is connected with and controls the external storage 10 by USB (universal serial bus).

Additionally, the ROM 1 can be EPROM; the RAM 2 is one of the following format: direct RDRAM (direct RAM bus DRAM) and SLDRAM (synchronous link DRAM); the internal storage 7 is one of the following interfaces: an IEEE-1394 interface, an IR-infrared interface, a RF interface and an IEEE 802.11b/g interface.

According to the above description, by the integration of the above system, the integral router device of the invention is of a smaller volume and less power consuming while operating; furthermore, the internal and external expansibility makes the invention more usable and practicable and makes the integral router of the invention more advanced in capacity, convenience and novelty; in addition, the integral router of the invention is potential and meritorious in practice for its simple stricture.

It is to be understood that while the invention has been described above in conjunction with preferred specific embodiments, the description and examples are intended to illustrate and do not limit the scope of the invention, which is defined by the scope of the appended claims.

1. An integral router device, comprising:
a ROM configured to store programs when operating hardware related to the programs;
a RAM configured to provide an area for temporarily storing processing data;
a processor configured to process the processing data;
a LAN interface configured to connect with an external network to transmit and receive data;
a wireless card configured to switch format of transmitted data and transmit and receive data by means of an antenna.

2. The integral router device according to claim 1, wherein said RAM is one of the following:
synchronous dynamic random access memory (SDRAM), double duration rate random access memory (DDR RAM), direct RAM BUS DRAM (RDRAM) and synchronous link DRAM (SLDRAM).

3. The integral router device according to claim 1, wherein said ROM is one of the following:
flash ROM, erasable and programmable ROM (EPROM) and electrically erasable and programmable ROM (EEPROM).

4. The integral router device according to claim 1, wherein said processor could be a central processor unit (CPU).

5. The integral router device according to claim 1, wherein said antenna is one of the following: a format of exposed outside a shell of the router and hided inside the shell of the router.

6. The integral router device according to claim 1, wherein said integral router device comprises an internal storage controller, an internal storage device, an internal storage controller and an external storage device.

7. The integral router device according to claim 6, wherein said internal storage controller is one of following interfaces to control the internal storage device: an integrated device electronic (IDE) interface, an IEEE-1394 interface and a universal serial bus (USB) interface.

8. The integral router device according to claim 6, wherein said external storage controller is one of the following interfaces to control the external storage device: an IEEE-1394 interface, a universal serial bus (USB) interface, an IR-infrared interface, a RF interface and an IEEE 802.22b/g interface.
